(19) United States
(12) Patent Application Publication
(10) Pub. No.: US 2013/0051323 A1
(43) Pub. Date: Feb. 28, 2013

(54) METHOD FOR COLLISION AVOIDANCE IN WIRELESS NETWORKS AND APPARATUS FOR THE SAME

(71) Applicants: Jun Keun SONG, Daejeon (KR); Woo Suk CHA, Jeollanam-do (KR); Hae Yong KIM, Daejeon (KR); Jong Soo JEONG, Daejeon (KR); Jin Sam KIM, Daejeon (KR); Duk Kyun WOO, Daejeon (KR); Seon Tae KIM, Daejeon (KR)

(72) Inventors: Jun Keun SONG, Daejeon (KR); Woo Suk CHA, Jeollanam-do (KR); Hae Yong KIM, Daejeon (KR); Jong Soo JEONG, Daejeon (KR); Jin Sam KIM, Daejeon (KR); Duk Kyun WOO, Daejeon (KR); Seon Tae KIM, Daejeon (KR)

(73) Assignee: Electronics And Telecommunications Research Institute, Daejeon (KR)

(21) Appl. No.: 13/592,882

(22) Filed: Aug. 23, 2012

(30) Foreign Application Priority Data
Aug. 24, 2011 (KR) 10-2011-0084697

(51) Int. Cl. H04W 28/00

(52) U.S. Cl. 370/328

(57) ABSTRACT

A collision avoidance method and an apparatus thereof in a wireless network are provided. The collision avoidance method in the wireless network includes receiving first data from a source node, determining whether a history in which data has been previously received from the source node is present, and determining a data transmission period of the source node based on the history when the history is present, and the data transmission period is calculated when data is received from the source node. Accordingly, a collision probability can be reduced in an environment in which wireless data is periodically transmitted in a CSMA/CA manner.

### CLAIM FOR PRIORITY

This application claims priority to Korean Patent Application No. 10-2011-0084697 filed on Aug. 24, 2011 in the Korean Intellectual Property Office (KIPO), the entire contents of which are hereby incorporated by reference.

### BACKGROUND

1. Technical Field

Example embodiments of the present invention relate in general to a collision avoidance method and an apparatus for the same, and more specifically to a collision avoidance method using periodic data in a wireless network and an apparatus for the same.

2. Related Art

An IEEE 802.15.4 standard has been growing quickly in terms of technical development and market formation in comparison with several competing wireless networking standards in the market such as Bluetooth, Wi-Fi, and the like. An ISO layer in a low rate wireless personal area network (LR-WPAN) such as Zigbee includes a physical (PHY) layer, a media access control (MAC) layer, a network (NWK) layer as a higher layer, an application support (APS) layer, a security (Security) layer, and an application (APL) layer. Among these layers, the IEEE 802.15.4 standard handles the PHY layer and the MAC layer. As a result, the IEEE 802.15.4 standard is becoming a standard technology of the LR-WPAN toward low complexity, low power consumption, and low data rate wireless data connectivity at the time of processing the PHY layer and the MAC layer to which a technique of preventing data collision is applied.

Basic regulations of the LR-WPAN comply with the standard defined in the IEEE 802.15.4 standard, and use the carrier sensing multiple access-collision avoidance (CSMA/CA) mechanism for channel allocation as in the IEEE 802.11 and the IEEE 802.15.3 based wireless networks. The CSMA/CA mechanism is divided into two modes in response to whether or not the slot is used, that is, a beacon mode in which a slotted CSMA/CA is used and a non-beacon mode in which an unslotted CSMA/CA is used.

The slotted CSMA/CA is used in a beacon-enabled network in such a manner that the backoff slot is allocated while the beacon frame is transmitted. A device waits for a random number of the synchronized backoff slots before transmitting data, and waits for a random number of the backoff slots when the channel is active. Here, it is necessary to carry out clear channel assessment (CCA) in order to protect the ACK frame.

On the other hand, unlike the beacon mode of the slotted CSMA/CA, a unit time of the backoff slot is not synchronized, which causes collision in the case of the non-beacon mode of the unslotted CSMA/CA, and data transmission fails.

Although many methods for reducing the data transmission failures have also been presented in the conventional IEEE 802.11 based wireless transmission, the CSMA/CA based transmission takes the majority in actual multihop and ad hoc situations. This is because that it is difficult to carry out TDMA-based scheduling by synchronizing the entire network, the data transmission efficiency is significantly low, and the transmission delay is increased when the TDMA mechanism is used. In addition, when it is not suitable for the standard, it is difficult to apply the methods to existing commercial products in which an algorithm is built in a chip as in the IEEE 802.11a/b/g/n. The same problems also occur in the case of the IEEE 802.15.4 standard used for low power communication.

Further, when the IEEE 802.15.4 standard is applied to a sensor network for monitoring, a backoff delay for avoiding collision is increased in a region in which traffic is concentrated such as a region around the sink, and hidden terminal problems that are difficult to be solved by the CSMA-CA are increased to cause retransmission to be frequently carried out.

In addition, request to send (RTS)/clear to send (CTS) is used to prevent the data collision beforehand in the IEEE 802.11 in order to avoid the hidden terminal problems, but is applied only to unicasting. Whether the data is transmitted or received is not confirmed in a multicasting or broadcasting environment. This is why a technique by which transmission situations can be predicted or the situation can be recognized in order to reduce the data collisions as much as possible and to transmit data more safely is necessary.

Therefore, it is necessary to provide a collision avoidance method in a wireless network and an apparatus for the same.

It is also necessary to provide a collision avoidance method using periodic data in a wireless network and an apparatus for the same.

### SUMMARY

Accordingly, example embodiments of the present invention are provided to substantially obviate one or more problems due to limitations and disadvantages of the related art.

An example embodiment of the present invention provides a collision avoidance method including receiving first data from a source node, determining whether a history in which data has been previously received from the source node is present, and determining a data transmission period of the source node based on the history when the history is present, and the data transmission period is calculated when data is received from the source node.

Another example embodiment of the present invention provides a collision avoidance method including determining a transmission time of the data using a data transmission period of a neighboring node before transmitting the data, calculating a collision probability with which the determined transmission time of the data collides with a transmission time of the neighboring node, and changing the data transmission period in response to a comparison result between the calculated collision probability and a critical collision probability.

According to the method of determining the transmission period in the wireless communication system and the apparatus for the same of the present invention described above, the collision probability at the time of transmission can be reduced in an environment in which wireless data is periodically transmitted in the CSMA/CA mechanism. In addition, the collision avoidance effect of the present invention can be obtained by predicting a transmission time of the periodic data in a wireless situation having a hidden terminal node problem, and the channel can be more effectively used considering up to the periodic data transmission of the 2-hop when it is difficult to confirm receipt of data as in a broadcast or multicast.

### BRIEF DESCRIPTION OF DRAWINGS

Example embodiments of the present invention will become more apparent by describing in detail example embodiments of the present invention with reference to the accompanying drawings, in which:

FIG. 1 is a diagram illustrating a backoff procedure in a slotted CSMA/CA manner in the general IEEE 802.15.4;

FIG. 2 is a diagram schematically illustrating an internal structure of a collision avoidance apparatus in a wireless network in accordance with an embodiment of the present invention;

FIG. 3 is a diagram illustrating a case in which a receiving node is included within a predictable backoff range even when a data transmission period of a transmitting node is out of a predetermined transmission period due to the backoff in a wireless network according to an embodiment of the present invention;

FIGS. 4A and 4B are diagrams illustrating cases in which data transmitted by a transmitting node is transmitted to a receiving node via at least one intermediate node in a wireless network according to an embodiment of the present invention;

FIG. 5 is a flowchart illustrating a collision avoidance method performed within a specific node in a wireless network according to an embodiment of the present invention; and

FIG. 6 is a flowchart illustrating a method of avoiding collision with a neighboring node when data is transmitted using an already calculated transmission period of the neighboring node performed in a specific node within a wireless communication environment according to an embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, A, B, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred example embodiments will be described in detail with reference to accompanying drawings.

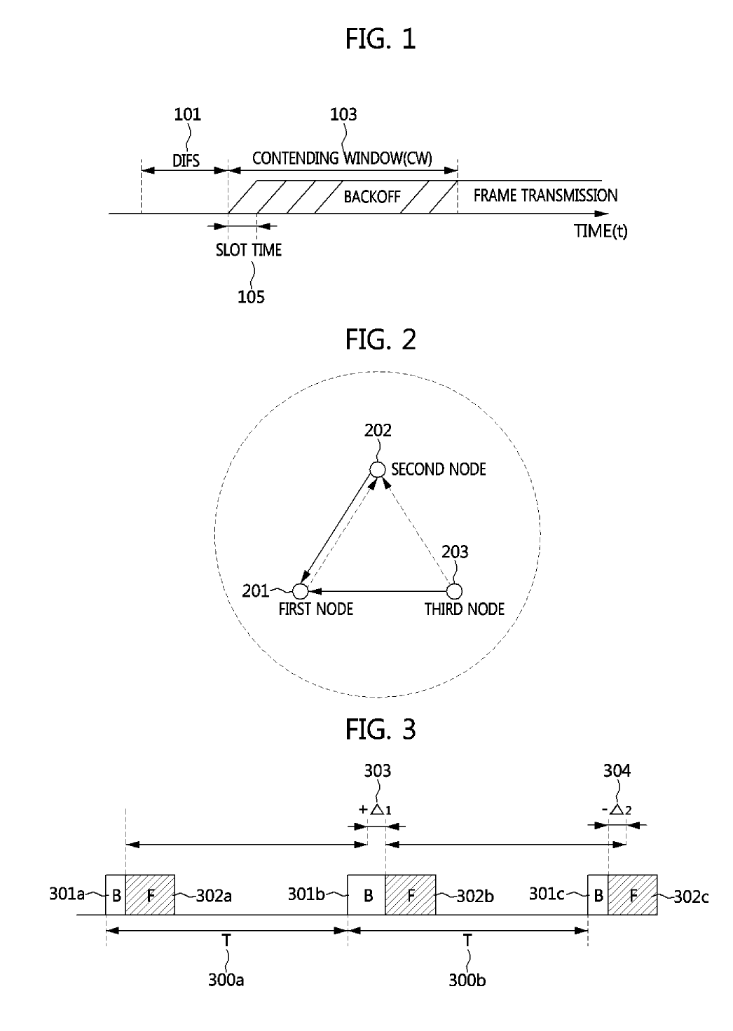

FIG. 1 is a diagram illustrating a backoff procedure in a slotted CSMA/CA mechanism in the general IEEE 802.15.4. In the embodiment illustrated in FIG. 1, the CSMA/CA algorithm has three variables such as number of backoff (NB), backoff exponent (BE), and contention window (CW). The NB indicates a number of times a node tries to access the channel in order to transmit a frame(data), the BE indicates a backoff index for determining the random backoff time, and the CW 103 indicates a counter used for CCA that is tried before data is transmitted.

A transmitting node having data to be transmitted initializes the NB and CW as 0 and 2, respectively. The transmitting node determines a battery life extension of the BE, and initializes the BE as, for example, 3 when the battery life extension is not used and initializes the BE as a smaller value between 2 and macMinBE when the battery life extension is used.

After a backoff period boundary is located, the transmitting node makes a delay by an integer number of unit backoffs that are randomly selected in a range of 0 to 2^{BE}−1 before trying to access the channel, and performs the CCA in order to examine whether the channel is being used. When the channel is active, the transmitting node initializes the CW, increments each of the NB and BE by 1, and checks whether the NB is greater than macMaxCSMABackoffs. When the NB is greater than macMaxCSMABackoffs, the transmitting node fails to access the channel.

Here, the transmitting node waits for the channel to remain in an idle state for DIFS 101 that is a minimum time for which a node should wait just after it has used a wireless medium for the last time when each node tries to access the wireless medium in a wireless LAN standard such as an 802.11 contention based service. The transmitting node performs the CCA, decreases the CW 103 by 1 when the channel is idle, and then performs a second CCA.

The transmitting node performs the second CCA, decreases the CW 103 by 1 again when the channel is idle, and accesses the channel when the CW 103 is 0. The transmitting node is given three retransmission opportunities when the transmitting node fails to access the channel or when contending terminals perform the CCA in the same slot to cause collision. It transmits data when the CCA is successful for the first and second times, and repeats the backoff procedure and the CCA procedure by the number of NB when the CCA is unsuccessful two times.

In this case, the time for which the transmitting node should wait is CW 103. For example, when the backoff procedure is 3, the time 3 of the backoff procedure corresponds to the number of the backoff procedures forming the CW 103. That is, when the backoff procedure is increased, the magnitude of the CW 103 is also increased. When a random number in a range of 0 to 2^{BE}−1 is 3, the time of the backoff procedure forming one CW 103 is 3. When two CCAs are performed to discern whether data can be transmitted in a current situation, six backoff procedures are necessary to perform the CCA in total. That is, the transmitting node transmits the data after waiting for the times of different backoff procedures.

FIG. 2 is a diagram schematically illustrating an internal structure of a collision avoidance apparatus in a wireless network in accordance with an embodiment of the present invention.

Referring to FIG. 2, a first node 201, a second node 202, and a third node 203 may be present in the wireless network. Although only three nodes are illustrated in the embodiment of FIG. 2, it is to be noted that more nodes may be present and the internal structure of FIG. 2 may be changed when the number of the nodes is increased.

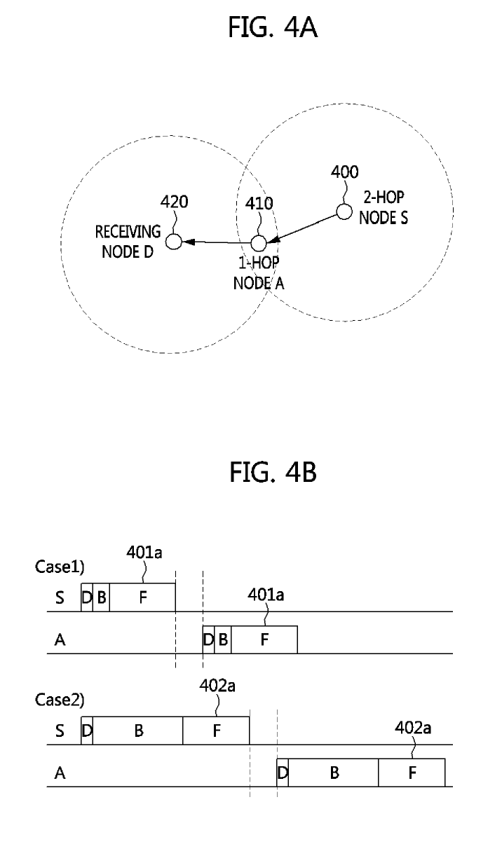

A plurality of nodes may be present in the wireless communication system, and a node may be a receiving node to receive data from a source node among the plurality of nodes and may be a transmitting node to transmit data to the source node among the plurality of nodes. In addition, data transmitted by the transmitting node may be directly transmitted to the receiving node, or may be transmitted to the receiving node via at least one intermediate node. In the embodiment of FIG. 2, a case in which the data transmitted by the transmitting node is directly transmitted to the receiving node will be described, and a case in which the data transmitted by the transmitting node is transmitted to the receiving node via at least one intermediate node will be described in detail with reference to FIGS. 4A and 4B that will be described later.

First, a case in which the first node 210 becomes the receiving node will be described. The first node 201 may receive data from adjacent nodes such as the second node 202 and the third node 203. In the case in which the first node 201 receives the data from the second node 202, the first node 201 receives the data from the second node 202, and determines whether a history in which data has been received from the second node 202 is present.

When it is determined that the history in which the first node 201 has received the data from the second node 202 is present and is not less than the predetermined minimum number of times the data is received, a data transmission period of the second node is determined. In this case, the first node 201 may determine the data transmission period using information such as interframe spacing (IFS), Preemble, or backoff slot time.

When it is determined that the history in which the first node 201 has received the data from the second node 202 is present and is not greater than the predetermined minimum number of times the data is received, information of the data received from the second node 202 is stored, and is transmitted to an upper layer. A case in which the first node 201 receives data from the third node 203 is the same as the case in which the first node 201 receives data from the second node 202, and a detailed description thereof is thus omitted.

Next, a case in which the first node 201 becomes a transmitting node will be described. The first node 201 calculates a probability of collision with the transmission time of the third node that is an adjacent node transmitting data to the second node. The first node 201 may calculate the probability of collision with the transmission time for which the third node transmits the data to the second node using the data transmission node of the third node.

In this case, since the first node 201 has received the data from the third node 203 when it is the receiving node as described above, the first node stores the data transmission period of the third node 203. Accordingly, the first node 201 may calculate the probability of collision with the transmission time for which the third node transmits the data to the second node using the data transmission period of the third node 203 stored in the first node.

The first node 201 calculates collision probability, and then compares the calculated collision probability with a predetermined collision probability to change the transmission time for which the data is transmitted to the second node 202. First, a case in which the first node 201 determines that the calculated collision probability is greater than the predetermined collision probability will be described. The first node 201 may delay the transmission time of data to be transmitted to the second node 202 by increasing the predetermined delay time and the contention window value to cause the data to be transmitted later than the data transmission period of the first node 201, thereby decreasing the probability of collision with the third node.

For another example in which the first node 210 transmits the data transmission time, the first node 201 may forcibly cause the standby time to occur to decrease the collision probability before transmitting the data, and may cause the standby time to occur using the backoff exponent (BE) that is a variable by which the length of the backoff is determined in the CSMA/CA algorithm to decrease the collision probability. Here, the BE is a backoff index, and indicates the number of backoff periods that are waited for before channel allocation is performed.

FIG. 3 is a diagram illustrating a case in which whether the receiving node should be included in the period determination is determined when the data transmission period of the transmitting node is out of the predetermined transmission period in a wireless communication network according to an embodiment of the present invention.

In the embodiment illustrated in FIG. 3, the procedure in which the second node 202 transmits data to the first node 201 and the first node 201 determines the data transmission node of the second node 202 will be described by way of example. The second node 202 waits for a time of the backoff procedure 301a, transmits first data 302a to the first node 201, waits for a time of the backoff procedure 301b, transmits second data 302b to the first node 201, waits for a time of the backoff procedure 301c, transmits second data 302c to the first node 201, and the first node 201 sequentially receives the first data 302a to third data 301c to determine the data transmission period of the second node 202.

The first node 201 receives the first data 302a, and updates the data transmission period of the second node 202 when the history received from the second node 202 is not less than the predetermined minimum number of times data is received.

The first node 201 then receives the second data 302b, determines that data is within periodic data when a difference between the time at which the second data 302b is received and the time at which the first data 302a is received is included in a threshold value that may occur due to the backoff even when the existing period 300a and the time difference 303 occur, and maintains the existing period. When the difference exceeds the threshold value, the first node 201 does not update the data transmission period of the second node 202.

In addition, the first node 201 receives the third data 302c, and also maintains the existing period when the difference between the time at which the third data 302c is received and the time at which the second data 302b is received is within a range of predetermined threshold values 304. When the second data 302b has not arrived or has arrived beyond the threshold value, it is examined whether the periodicity of the third data 302c satisfies the period corresponding to the integer times the existing periodicity and data that has already been received.

FIGS. 4A and 4B are diagrams illustrating cases in which data transmitted by a transmitting node is transmitted to a receiving node via at least one intermediate node in a wireless network according to an embodiment of the present invention. In the embodiment illustrated in FIG. 4A, a procedure in which data is transmitted to the receiving node D 420 via the 1-hop node A 410 when the 2-hop node S 400 transmits the data to the receiving node D 420 will be described.

Data is transmitted to the receiving node D 420 via at least one 1-hop node A 410 when the 2-hop node S 400 transmits the data to the receiving node D 420. The receiving node D 420 determines whether a history received from the 2-hop node S 400 and the 1-hop node A 410 is present, and calculates and stores the data transmission period of the 2-hop node S 400 and the 1-hop node A 410 when the history is not less than a predetermined number.

The receiving node D 420 then calculates the probability of collision with the transmission time of the 2-hop node S 400 that transmits the data to a third node when the receiving node transmits the data to the third node (not shown). In this case, since the receiving node D 420 stores the data transmission periods of the 2-hop node S 400 and the 1-hop node A 410, the receiving node can use the data transmission periods to calculate the collision probability. The receiving node D 420 changes the transmission time at which the data is transmitted to the third node 203 in response to the collision probability. In this case, the receiving node D 420 may change the transmission time by adjusting the predetermined delay time and the backoff time, thereby decreasing the collision probability.

However, the random backoff has the highest influence on the transmission time as described above, and the corresponding value is a random value determined in the 2-hop node S 400, so that it is difficult to carry out exact prediction. Accordingly, the receiving node D 420 uses the past receipt information of the 2-hop node S 400 or the best case such as CASE 2 at the time of the worst case such as CASE 1 of FIG. 4B to predict the data transmission start time.

Here, CASE 1 is the worst because the backoff time that is a standby time for causing the 2-hop node S 400 to transmit the first data 401a to the 1-hop node A 410 and the backoff time that is a standby time for causing the 1-hop node A 410 to transmit the first data 401a received from the 2-hop node S 400 to the receiving node D 420 are short, and the transmission failure may thus occur due to the collision occurring when another node transmits data between the backoff times.

In addition, CASE 2 is the best because the backoff time that is a standby time for causing the 2-hop node S 400 to transmit the first data 401a to the 1-hop node A 410 and the backoff time that is a standby time for causing the 1-hop node A 410 to transmit the first data 401a received from the 2-hop node S 400 to the receiving node D 420 are long, and the 2-hop node S 400 and the 1-hop node A 410 are thus in a standby state when another node transmits data between the backoff times, so that the collision probability is low to have a low transmission failure probability.

In addition, the receiving node D 420 may also use a frequency for predicting how many times the period is out of the range at the time of determining the periodicity mentioned above. The receiving node D 420 examines the collision probability, and then carries out the collision avoidance task when it determines that the collision probability is higher than a predetermined threshold value. The collision avoidance may be stochastically reduced by forcibly causing the delay to occur or changing the BE value on the CSMA/CA algorithm before transmission.

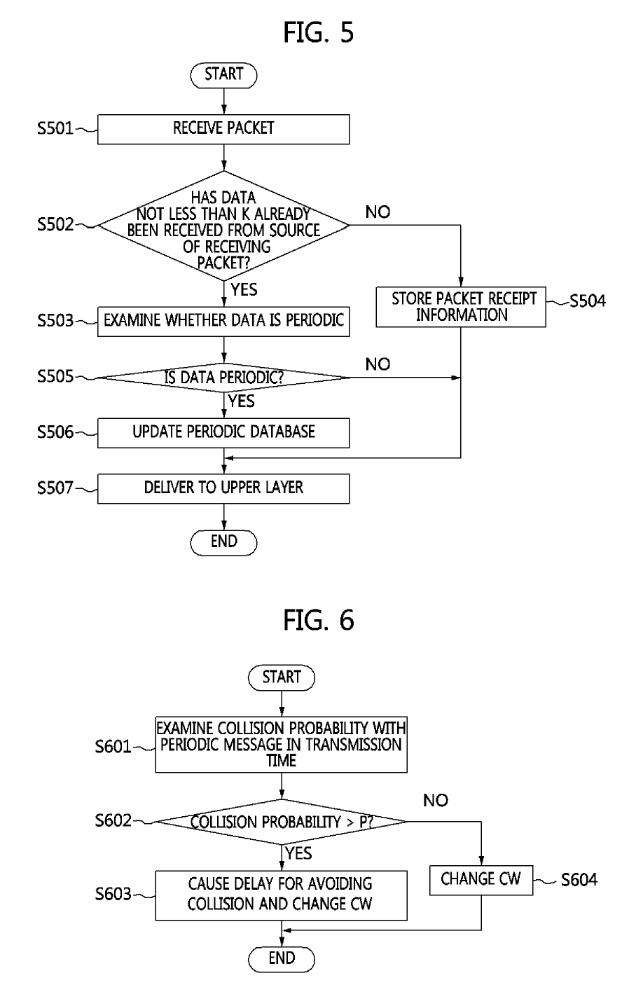

FIG. 5 is a flowchart illustrating a collision avoidance method performed within a specific node in a wireless network according to an embodiment of the present invention.

Referring to FIG. 5, the first node 201 receives data from the second node 202 among adjacent nodes (S501). The first node 201 determines whether a history in which data has been received from the second node 202 is present, and determines and stores the data transmission period of the second node 202 (S504) when it determines that the history is not less than a predetermined minimum number of times data is received (S502). In this case, the first node 201 may use setting values such as IFS, Preemble, or backoff slot time to determine the data transmission period of the second node 202.

On the other hand, when the first node 201 determines that the history in which the data has been received from the second node 202 is present and the history is not more than the predetermined minimum number of times data is received, the first node stores information on data received from the second node 202 and transmits it to an upper layer (S507). Information such as the received time or a magnitude of the received data may be included in the information on the received data, and the corresponding information may also be included when a periodic database is updated.

FIG. 6 is a flowchart illustrating a method of avoiding collision with a neighboring node when data is transmitted using an already calculated transmission period of the neighboring node performed in a specific node within a wireless communication environment according to an embodiment of the present invention.

Referring to FIG. 6, the first node 201 uses the data transmission period of the third node to calculate a probability of collision with the transmission time for which the third node transmits data to the second node before transmitting the data to the second node 202 (S601). In this case, since the first node 201 stores the data transmission period of the third node 203 determined when receiving the data, the first node can thus use the data transmission period to calculate the collision probability.

The first node 201 compares the calculated collision probability with a critical collision probability (S602), and causes the delay for avoiding the collision to occur and changes the CW when it determines that the calculated collision probability is higher than the critical collision probability (S603). On the other hand, the source node 100 changes the CW when it determines that the calculated collision probability is not higher than the critical collision probability (S604).

While the example embodiments of the present invention and their advantages have been described in detail, it should be understood that various changes, substitutions and alterations may be made herein without departing from the scope of the invention.

What is claimed is:

1. A method of avoiding data collision to be performed in a specific node within a wireless communication environment, the method comprising:
receiving first data from a source node;
determining whether a history in which data has been previously received from the source node is present; and
determining a data transmission period of the source node based on the history when the history is present,
wherein the data transmission period is calculated when data is received from the source node.

2. The method according to claim 1, wherein the data transmission period of the source node is determined using at least one of network setting values including interframe spacing (IFS), Preemble, and backoff slot time.

3. The method according to claim 1, wherein the data transmission period of the source node is determined only when a number of times data has previously been received from the source node is not less than a predetermined minimum number of times data has been received, and the determined data transmission period of the source node is stored in a transmission period database.

4. The method according to claim 3, wherein when a data transmission period that is previously determined with respect to the source node is present in the transmission period database, a difference between the determined data transmission period of the source node and the data transmission period that is previously determined is calculated, and the data transmission period of the source node is not stored in the database when the difference exceeds an acceptable limit.

5. The method according to claim 1, wherein the specific node is a node present in at least one hop between 1-hop and 2-hop.

6. A method of avoiding collision with a neighboring node at the time of transmitting data using an already calculated data transmission period of the neighboring node performed in a specific node within a wireless communication environment, the method comprising:
determining a transmission time of the data using the data transmission period of the neighboring node before transmitting the data;
calculating a collision probability with which the determined transmission time of the data collides with a transmission time of the neighboring node; and
changing the data transmission period in response to a comparison result between the calculated collision probability and a critical collision probability.

7. The method according to claim 6, wherein, when the collision probability is greater than the critical collision probability, a delay time and a contention window value are determined based on information or a period that has been received and are reflected to cause the data to be transmitted later than the data transmission period.

8. The method according to claim 6, wherein, when the data is transmitted to a source node via at least one intermediate node, the data transmission period is changed using data transmission periods of the source node and the intermediate node.

9. The method according to claim 6, wherein the data transmission period is determined using at least one of network setting values including interframe spacing (IFS), Preemble, and backoff slot time.

10. The method according to claim 6, wherein the neighboring node is a node present in at least one hop between 1-hop and 2-hop.
